(19) United States
(12) Patent Application Publication
(10) Pub. No.: US 2009/0066587 A1
(43) Pub. Date: Mar. 12, 2009

(54) ELECTRONIC DEVICE WITH CAP MEMBER ANTENNA ELEMENT

(76) Inventors: Gerard James HAYES, Wake Forest, NC (US); Curtis W. Thornton, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/853,882

(22) Filed: Sep. 12, 2007

(51) Int. Cl. H01Q 1/22

(52) U.S. Cl. 343/702

(57) ABSTRACT

An electronic device includes a main body having electronic circuitry therein, and further includes an exposed interface that enables the electronic circuitry to transfer information. In addition, the electronic device includes a cap member releasably attachable to the main body in at least a first position and a second position, the cap member including at least one antenna element. The cap member covers the exposed interface when attached to the main body in the first position, and when the cap member is attached to the main body in the second position, the antenna element serves as an antenna for transmitting and/or receiving information wirelessly in conjunction with the electronic circuitry.

### TECHNICAL FIELD OF THE INVENTION

The present invention relates generally to wireless electronic devices, and more particularly to antennas used therein.

### DESCRIPTION OF THE RELATED ART

As is known, for communication devices (e.g., computers, cellular telephones, printers, game consoles, control devices, personal digital assistants, etc.) to communicate, they need a wired or wireless connection. As is also known, there are many standards that dictate the signaling protocol and/or hardware protocol for wired communications and wireless communications. Further, many massed produced devices, such as computers, PDAs, cellular telephones, etc., include communication circuitry to support one or more wired and/or wireless standards. Such wired standards include Ethernet, universal serial bus, fire wire, etc., and wireless standards include IEEE 802.11, Bluetooth, and extensions thereof, etc.

Situations oftentimes arise where it is desirable to equip a communication device with a wireless adapter to enable the communication device to communicate via one of the wireless standards or the like. Such wireless adapters can be in the form of a universal serial bus (USB) dongle that incorporate an IEEE 802.11, Bluetooth, or other type wireless interface, as are known. The USB dongle includes a USB connector for engaging a corresponding USB connector in the communication device, such as a personal computer. Within the dongle is electronic circuitry that serves as an interface between the communication device and a wireless network.

In order to enable the electronic circuitry to communicate over the wireless network, the USB dongle or other type portable wireless adaptor includes at least one antenna therein. The electronic circuitry uses the antenna to transmit and/or receive information wirelessly via the network.

USB dongles and other portable wireless adaptors typically have a small profile by design. Otherwise, the adaptors tend to occupy an undesirable amount of space. For example, the further the body of a USB dongle extends from the USB port of a communication device, the more likely the dongle will inadvertently become caught on an obstruction and perhaps broken. Furthermore, the larger the USB dongle or other type adaptor, the less convenient it is to transport and store the adaptor (e.g., in one's shirt pocket). Moreover, smaller dongles are typically considered more attractive cosmetically.

Due to these types of mechanical and/or cosmetic constraints on the size of the USB dongle or other portable wireless adaptor, the availability of space therein for the antenna is limited. The antenna must share space within the adaptor with the remaining electronic circuitry. Consequently, the antenna must be relatively small in order to fit within the available space. On the other hand, such a small antenna offers a relatively low, and perhaps insufficient, amount of gain thereby reducing the range of the wireless adaptor. Thus, while users typically prefer that the wireless adaptor provide extended range, the mechanical and/or cosmetic constraints placed on the antenna can limit range undesirably.

In view of the aforementioned shortcomings of USB dongles and other portable wireless adaptors and devices, there is a strong need in the art for a construction that provides a small profile without necessarily sacrificing the size and gain of the antenna.

### SUMMARY

According to an aspect of the invention, an electronic device is provided. The electronic device includes a main body having electronic circuitry therein, and further includes an exposed interface that enables the electronic circuitry to transfer information. In addition, the electronic device includes a cap member releasably attachable to the main body in at least a first position and a second position, the cap member including at least one antenna element. The cap member covers the exposed interface when attached to the main body in the first position, and when the cap member is attached to the main body in the second position, the antenna element serves as an antenna for transmitting and/or receiving information wirelessly in conjunction with the electronic circuitry.

According to an aspect, the cap member includes a first electrical connector coupled to the at least one antenna element, the main body includes a second electrical connector coupled to the electronic circuitry, and the first and second electrical connectors are configured to mate with one another when the cap member is attached to the main body in the second position.

According to another aspect, the at least one antenna element includes a monopole element.

According to another aspect, the monopole element is at least one of a helical element or a serpentine element.

According to yet another aspect, the cap member is made of a dielectric material and the at least one antenna element is embedded within the dielectric material.

According to still another aspect, the main body has an elongate shape with the first and second positions being located at two respective ends, and the exposed interface is an electrical interface connector for connecting the electronic circuitry to another device.

In accordance with another aspect, the electrical interface connector comprises a USB connector.

In still another aspect, the main body is a dongle.

According to another aspect, the electronic device is a wireless interface.

In accordance with yet another aspect, the electronic device serves as an interface between another device connected to the exposed interface and a wireless network.

In still another aspect, the wireless network comprises an IEEE 802.11 network.

According to yet another aspect, the wireless network comprises a mobile phone network.

In accordance with another aspect, the wireless network comprises a Bluetooth network.

According to another aspect, the cap member is releasably attachable to the main body in the first and second positions by at least one of a friction fit or a snap fit.

With still another aspect, the cap member is releasably attachable to the main body in the first and second positions via a pivoting member further included in the electronic device, the pivoting member enabling the cap member to rotate about the main body from the first position to the second position.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a perspective view of an electronic device including a cap member having an integrated antenna in a first position according to an embodiment of the invention;

FIG. 2 illustrates the electronic device of FIG. 1 with the cap member in a second position in accordance with the invention;

FIG. 3 is a rear perspective view of the electronic device of FIG. 1 with the cap member in the first position in accordance with the invention;

FIG. 4 is a front perspective view of the cap member in accordance with the present invention;

FIGS. 5 and 6 illustrate schematically top and cross-sectional side views, respectively, of the cap member in an embodiment in which the antenna is a helical monopole;

FIG. 7 is a schematic top view of the cap member in another embodiment in which the cap member includes a plurality of serpentine monopole elements;

FIGS. 8 and 9 are schematic diagrams of the electronic device of claim 1 with the cap in the first position and adjacent the second position, respectively, in accordance with the invention; and

FIGS. 10 and 11 are perspective views of an electronic device according to another embodiment of the invention, with the cap member in the first and second positions respectively.

### DETAILED DESCRIPTION OF EMBODIMENTS

The present invention will now be described with reference to the drawings, in which like reference labels are used to refer to like elements throughout.

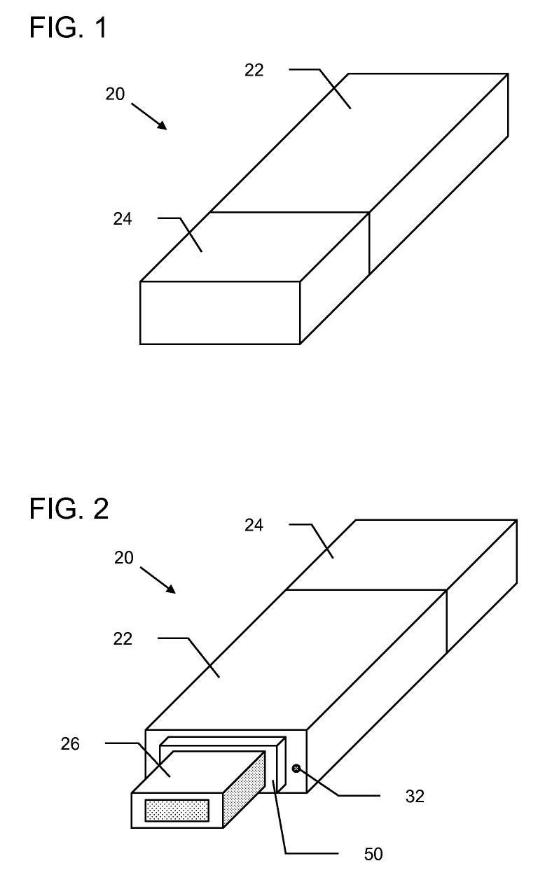

Referring initially to FIGS. 1 and 2, an electronic device 20 is shown in accordance with an exemplary embodiment of the present invention. According to this particular embodiment, the electronic device 20 is a USB dongle. However, it will be appreciated based on the disclosure presented herein that the invention also has utility with various other types of electronic devices which may utilize a cap member and antenna. The present invention, in its broadest sense, is not limited to any particular type of electronic device.

The USB dongle 20 includes a main body 22 and a cap member 24. Included within the main body 22 is electronic circuitry (not shown) that enables the USB dongle 20 to function as IEEE 802.11 or Bluetooth wireless adaptor, a wireless adaptor providing mobile phone service connectivity, etc. As is shown in FIG. 2, the main body 22 includes an exposed mechanical interface 26 such as a USB style plug. The interface 26 is designed to fit into the USB port of another device (not shown) such as a personal computer, notebook computer, mobile phone, personal digital assistant, etc. As is known, the interface 26 enables the electronic circuitry within the dongle 20 to communicate therebetween.

The cap member 24 is configured so as to be releasably attachable to the main body 22 in at least a first position as shown in FIG. 1, and a second position as shown in FIG. 2. As will be described in more detail below, the cap member 24 of the present invention includes an antenna element or elements integrated therein. When attached to the main body 22 in the first position (FIG. 1), the cap member 24 functions conventionally to cover the exposed interface 26. The cap member 24 thereby helps to prevent the interface 26 on the main body 22 from being damaged, collecting dust or debris, etc.

Additionally, however, when the cap member 24 is attached to the main body 22 in the second position (FIG. 2), the antenna element serves as an antenna for transmitting and/or receiving information wirelessly in conjunction with the electronic circuitry included in the main body 22. As a result, the antenna in the cap member 24 is operative as an antenna without occupying space within the main body 22. This enables the dongle 20 to possess a larger antenna within the cap member 24 to provide better gain than an antenna limited in size by the space available in the main body 22. In addition, or in the alternative, the overall size of the main body 22 may be reduced compared to a conventional device in the sense that the main body 22 no longer must house the antenna itself. The shape and size of the antenna element is limited only by the size of the cap member 24. The antenna element within the cap member 24 may represent the entire antenna for the electronic circuitry in the main body 22, an extension of an existing antenna within the main body 22, or simply an antenna in addition to the antenna already existing within the main body 22.

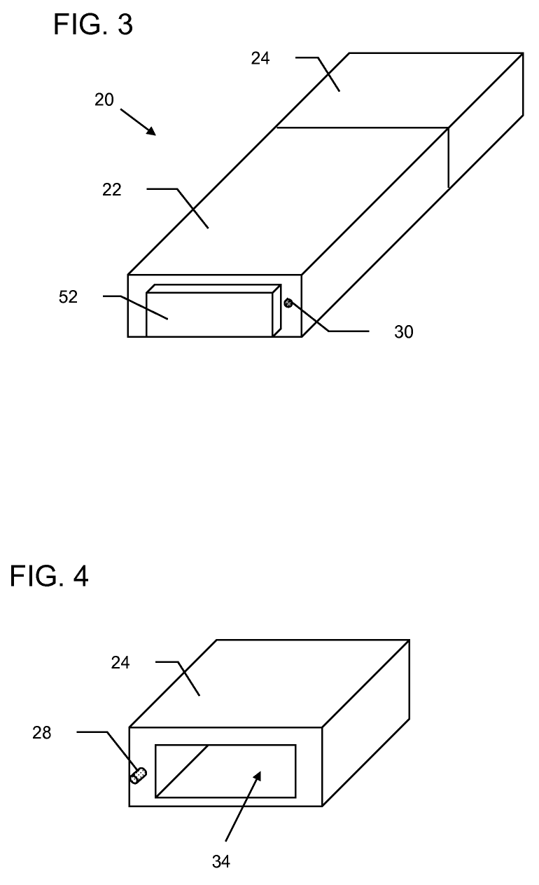

Referring to FIGS. 3 and 4, the cap member 24 includes a first electrical connector 28 coupled to the at least one antenna element therein. The main body 22 includes a second electrical connector 30 coupled to the electronic circuitry therein. The first electrical connector 28 and the second electrical connector 30 are configured to mate with one another to form a radio-frequency (RF) connection when the cap member 24 is attached to the main body 22 in the second position (FIG. 2). This enables RF signals that are received by the antenna(s) within the cap member 24 to be input to an RF receiver included in the electronic circuitry within the main body 22. Similarly, an RF transmitter within the main body 22 may provide a signal to be transmitted to the antenna(s) within the cap member 24. Thus, it will be appreciated that the dongle 20 may serve as a conventional wireless adaptor enabling a device connected via the interface 26 to communicate with other devices via a surrounding wireless network.

It is noted that in the embodiment of FIGS. 1-4, the electrical connector 28 is a male connector and the electrical connector 30 is a female connector. Consequently, the main body 22 also includes a female connector 32 adjacent the interface 26 for accommodating the connector 28 when the cap member 24 is in the first position. The female connector 32 may be coupled to the electronic circuitry within the main body 22 such that the antenna within the cap member 24 is functional for an intended purpose even when the interface 26 is not being used. Alternatively, the connector 32 may merely be a dummy connector simply to accommodate the connector 28.

Of course, various other types of connectors for forming an RF connection between the cap member antenna and the electronic circuitry within the main body 22 may be utilized without departing from the scope of the invention.

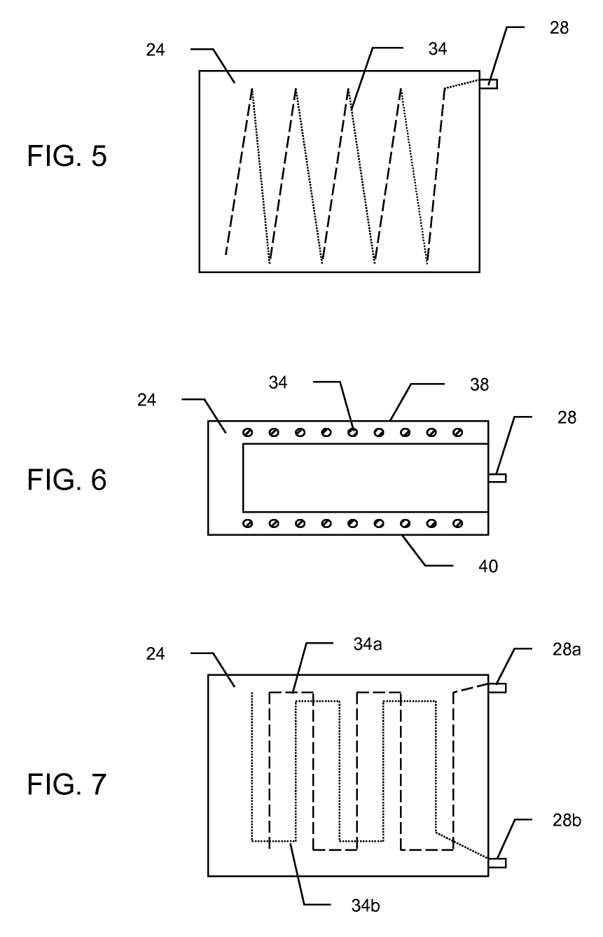

FIGS. 5 and 6 represent an embodiment of the cap member 24 including a helix monopole antenna element 34 therein. The cap member 24 includes a cavity 36 designed to accommodate the interface 26. The helix antenna element 34 is embedded within the body of the cap member 24 and wraps around the circumference of the cavity 36 as shown. The antenna element 34 can be made of an electrically conductive wire such as copper, for example. The cap member 24 is made of an RF-compatible dielectric material such as plastic or the like. In an exemplary embodiment, the antenna element 34 is molded within the plastic cap member 24 and coupled to the electrical connector 28 as previously discussed. In an alternative embodiment, the antenna element may have a different design, such as a serpentine layout within the cap member 24.

FIG. 7 illustrates an embodiment in which the cap member 24 includes a pair of antenna elements 34a and 34b coupled to electrical connectors 28a and 28b, respectively. In this embodiment, elements 34a and 34b each have a serpentine design and are embedded in a top face 38 and bottom face 40 (FIG. 6) of the cap member 24, respectively. In this embodiment, since there are multiple electrical connectors 28a and 28b, it will be appreciated that the main body 22 will have a corresponding number of connectors designed to engage those of the cap member 24.

Those having ordinary skill in the art will appreciate that the particular number and type of antenna elements included in the cap member 24 need not be limited in the broadest sense of the invention.

In the exemplary embodiment, the main body 22 has an elongate shape with the first and second positions of the cap member 24 being located at the respective ends. However, it will be appreciated that other shapes and configurations are possible and are considered to be within the scope of the invention.

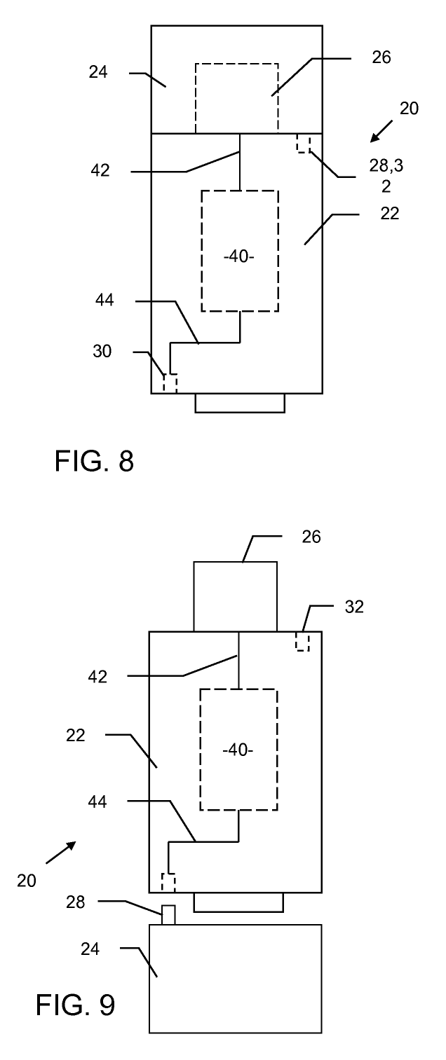

FIGS. 8 and 9 illustrate schematically the main body 22 including electronic circuitry 40 therein. The electronic circuitry 40 is connected to the interface 26 via bus 42 for communicating with the personal computer, notebook computer, etc., connected thereto. Additionally, the electronic circuitry 40 is connected to electrical connector 30 via line 44. Thus, when the cap member 24 is in the second position, the antenna element 34 within the cap member 24 is coupled to the electronic circuitry 40 via the connector 28 as represented in FIG. 9.

According to the embodiment of FIGS. 1-4, the cap member 24 is releasably attached to the main body 22 in the first and second positions by way of friction fit. For example, FIG. 4 illustrates how the cap member 24 includes the aforementioned cavity 36 for accommodating the interface 26. The dimensions of the cap member 24 defining the cavity 36 are designed so as to engage in a friction fit a mount 50 surrounding the interface 26 as shown in FIG. 2. A mount 52 having the same dimensions as the mount 50 is provided on the opposite end of the main body 22 as shown in FIG. 3. Thus, a user may easily attach and detach the cap member 24 from the first and second positions. In another embodiment, the cap member 24 may be designed to engage in a snap fit with the main body 22 using known snap fit techniques.

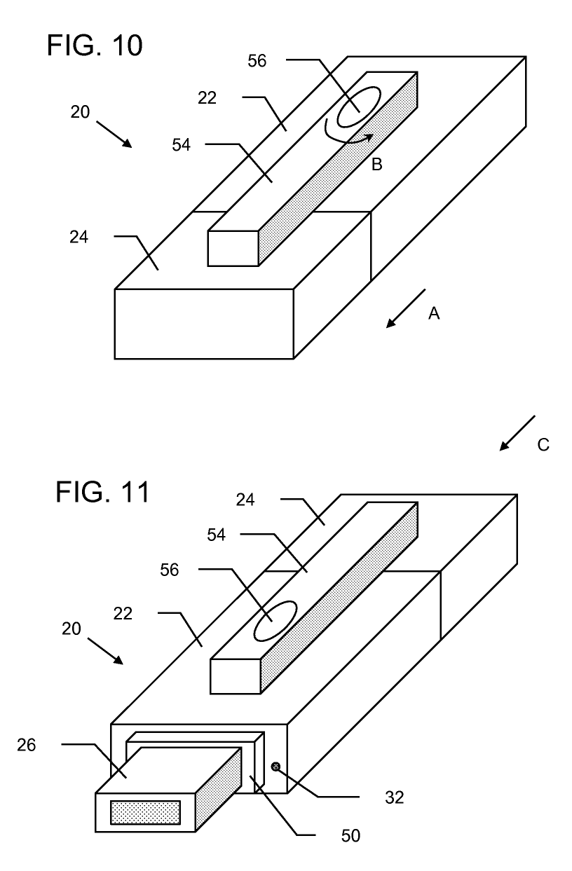

FIGS. 10 and 11 illustrate another embodiment that includes a swing mechanism for releasably attaching the cap member 24 at the first and second positions. FIG. 9 illustrates the dongle 20 with the cap member 24 in the first position covering the interface 26. FIG. 10 shows the same dongle 20 with the cap member 24 in the second position so as to serve as an antenna for the electronic circuitry within the main body 22 in the same manner described above.

In the embodiment of FIGS. 10 and 11, the dongle 20 includes one or more pivoting arms 54. For example, a pivoting arm 54 is provided on a top surface of the main body 22. The pivoting arm 54 is mounted to the main body 22 at one end at a pivot axis 56 so as to pivot generally around the pivot axis 56. The other end of the pivoting arm 54 is secured to the cap member 24. A similar pivoting arm 54 may be provided on the bottom surface of the main body 22 (not shown).

The pivoting arm(s) 54 is spring loaded at the pivot axis 56 in order to permit the pivoting arm 54 to shift radially in the direction of arrow A. The pivoting arm 54 is able to shift a sufficient distance such that the face of the cap member 24 having the connector 28 is able to disengage from the mount 50 and clear the distal end of the interface 26 as the cap member 24 is rotated about the pivot axis 56 (e.g., in the direction of arrow B). The cap member 24 is rotated to the opposite end of the main body 22 and is retracted by the spring loaded pivot axis radially back in the direction of arrow C as shown in FIG. 11 so as to engage the mount 52. At the same time, the connector 28 engages the connector 30. As a result, the antenna 34 within the cap member 22 is connected to the electronic circuitry 40 in same the manner described above.

Accordingly, the present invention provides a construction for USB dongles and other portable devices that enables a small profile without necessarily sacrificing the size and gain of the antenna.

The term “electronic device” as referred to herein includes wireless adaptors and other types of portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. An electronic device, comprising:
a main body including electronic circuitry therein, and further including an exposed interface that enables the electronic circuitry to transfer information; and
a cap member releasably attachable to the main body in at least a first position and a second position, the cap member including at least one antenna element,
wherein the cap member covers the exposed interface when attached to the main body in the first position; and
when the cap member is attached to the main body in the second position, the antenna element serves as an antenna for transmitting and/or receiving information wirelessly in conjunction with the electronic circuitry.

2. The electronic device of claim 1, wherein the cap member includes a first electrical connector coupled to the at least one antenna element, the main body includes a second electrical connector coupled to the electronic circuitry, and the first and second electrical connectors are configured to mate with one another when the cap member is attached to the main body in the second position.

3. The electronic device of claim 1, wherein the at least one antenna element comprises a monopole element.

4. The electronic device of claim 3, wherein the monopole element is at least one of a helical element or a serpentine element.

5. The electronic device of claim 1, wherein the cap member is made of a dielectric material and the at least one antenna element is embedded within the dielectric material.

6. The electronic device of claim 5, wherein the main body has an elongate shape with the first and second positions being located at two respective ends, and the exposed interface is an electrical interface connector for connecting the electronic circuitry to another device.

7. The electronic device of claim 6, wherein the electrical interface connector comprises a USB connector.

8. The electronic device of claim 1, wherein the main body is a dongle.

9. The electronic device of claim 1, wherein the electronic device is a wireless interface.

10. The electronic device of claim 9, wherein the electronic device serves as an interface between another device connected to the exposed interface and a wireless network.

11. The electronic device of claim 10, wherein the wireless network comprises an IEEE 802.11 network.

12. The electronic device of claim 10, wherein the wireless network comprises a mobile phone network.

13. The electronic device of claim 10, wherein the wireless network comprises a Bluetooth network.

14. The electronic device of claim 1, wherein the cap member is releasably attachable to the main body in the first and second positions by at least one of a friction fit or a snap fit.

15. The electronic device of claim 1, wherein the cap member is releasably attachable to the main body in the first and second positions via a pivoting member further included in the electronic device, the pivoting member enabling the cap member to rotate about the main body from the first position to the second position.
